(19) United States
(12) Patent Application Publication
(10) Pub. No.: US 2007/0220973 A1
(43) Pub. Date: Sep. 27, 2007

(54) Multi-axis micromachined accelerometer and rate sensor

(76) Inventor: Cenk Acar, Irvine, CA (US)

Correspondence Address: EDWARD S. WRIGHT, 1100 ALMA STREET, SUITE 207, MENLO PARK, CA, 94025, US

(21) Appl. No.: 11/734,156

(22) Filed: Apr. 11, 2007

Related U.S. Application Data
(63) Continuation-in-part of application No. 11/203,074, filed on Aug. 12, 2005.

(51) Int. Cl. G01P 15/08

(52) U.S. Cl. 73/504.12

(57) ABSTRACT

Multi-axis micromachined accelerometer and rate sensor having first and second generally planar masses disposed side-by-side and connected together along adjacent edge portions thereof for torsional movement about axes parallel to a first axis in response to acceleration along a second axis and for rotational motion about axes parallel to the second axis in response to acceleration along the first axis. The masses are driven to oscillate about the axes parallel to the second axis so that Coriolis forces produced by rotation about a third axis result in torsional movement of the masses about the axes parallel to the first axis. Sensors monitor the movement of the mass about the axes, and signals from the sensors are processed to provide output signals corresponding to acceleration along the first and second axes and rotation about the third axis.

### CROSS-REFERENCE TO RELATED APPLICATION

This is a continuation-in-part of Ser. No. 11/203,074, filed Aug. 12, 2005.

### BACKGROUND OF THE INVENTION

1. Field of Invention

This invention pertains generally to micromachined accelerometers and rate sensors, more particularly, to a combined accelerometer and rate sensor for monitoring acceleration an angular rotation about multiple axes.

2. Related Art

Multi-axis micromachined accelerometers and rate sensors heretofore provided have been subject to certain limitations and disadvantages.

Multi-axis accelerometers are subject to undesirable cross axis sensitivity where deflection of the proof mass due to acceleration along one axis results in a slight change in the geometry of the electrodes for detecting acceleration along another axis.

While there have been some attempts to combine multi-axis accelerometers and rate sensors into a single device, there is a need for a device which can serve as a yaw rotation sensor as well as detecting lateral and longitudinal acceleration of a vehicle.

### OBJECTS AND SUMMARY OF THE INVENTION

It is in general an object of the invention to provide a new and improved multi-axis micromachined accelerometer and rate sensor.

Another object of the invention is to provide a multi-axis micromachined accelerometer and rate sensor of the above character which is particularly suitable for use in monitoring lateral acceleration, longitudinal acceleration and yaw rotation of a vehicle.

These and other objects are achieved in accordance with the invention by providing a multi-axis micromachined accelerometer and rate sensor having a mass mounted for torsional movement about a first axis in response to acceleration along a second axis and for rotational motion about the second axis in response to acceleration along the first axis, with means for driving the mass to oscillate about the second axis so that Coriolis forces produced by rotation about a third axis result in torsional movement of the mass about the first axis. Sensors monitor the movement of the mass about the axes, and signals from the sensors are processed to provide output signals corresponding to acceleration along the first and second axes and rotation about the third axis.

### BRIEF DESCRIPTION OF THE DRAWINGS

FIG. 1 is a top plan view of one embodiment of a multi-axis micromachined accelerometer.

FIG. 2 is a top plan view of another embodiment of a multi-axis micro-machined accelerometer.

FIG. 3 is a top plan view of an embodiment of a multi-axis micromachined accelerometer which can also be used as an angular rate sensor.

FIG. 4 is a top plan view of another embodiment of a multi-axis micro-machined accelerometer.

FIG. 5 is a top plan view of another embodiment of a multi-axis micromachined accelerometer which can also be used as an angular rate sensor.

FIG. 6 is a fragmentary cross-sectional view taken along line 6-6 in FIG. 5.

FIGS. 7 and 8 are views similar to FIG. 6 of additional embodiments of micromachined accelerometers which can also be used as rate sensors.

FIG. 9 is a top plan view and block diagram of one embodiment of a micromachined accelerometer and rate sensor incorporating the invention.

FIG. 10 is an isometric view illustrating use of the embodiment of FIG. 9 for monitoring lateral acceleration, longitudinal acceleration and yaw rotation in a vehicle.

### DETAILED DESCRIPTION

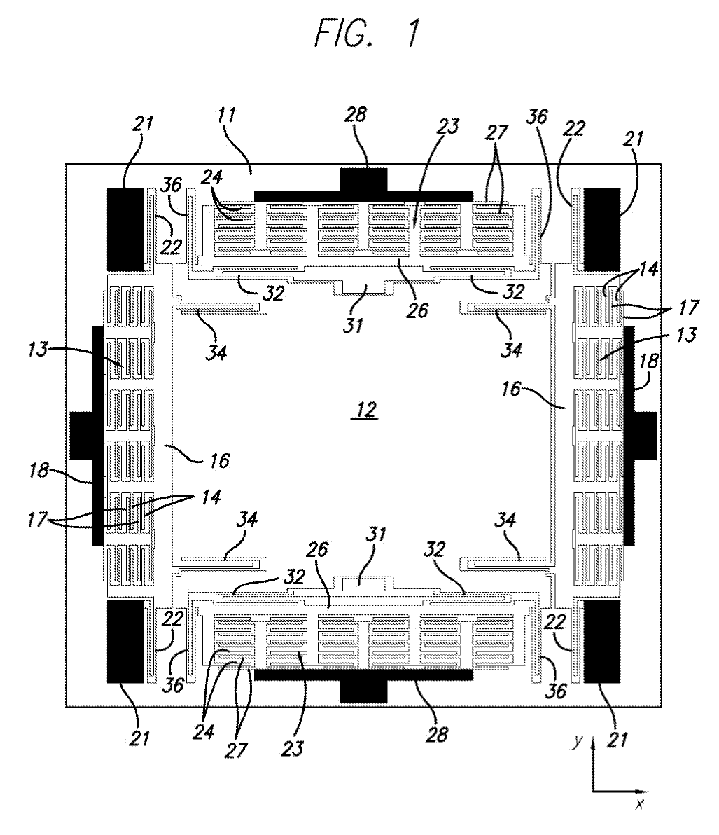

As illustrated in FIG. 1, the accelerometer has a generally planar substrate 11 which is fabricated of a suitable material such as silicon, with a generally planar proof mass 12 suspended above the substrate for movement in a plane parallel to the substrate in response to acceleration along mutually perpendicular x and y input axes which lie in the plane.

Movement of the proof mass in response to acceleration along the x-axis is monitored by capacitive detectors 13 having input electrodes or plates 14 which are mounted on movable frames 16 and interleaved with fixed electrodes or plates 17 which are mounted on frames 18 anchored to the substrate. The movable frames are suspended from anchors 21 by folded suspension beams 22 for linear movement in the x-direction. Beams 22 extend in the y direction and are flexible in the x-direction but relatively stiff in the y and z directions so as to constrain the frames for movement in the x-direction only.

Movement of the proof mass in response to acceleration along the y-axis is monitored by capacitive detectors 23 having input electrodes or plates 24 which are mounted on movable frames 26 and interleaved with fixed electrodes or plates 27 which are mounted on frames 28 anchored to the substrate. Movable frames 26 are suspended from anchors 31 by folded suspension beams 32 for linear movement in the y-direction. Beams 32 extend in the x direction and are flexible in the y-direction but relatively stiff in the x and z directions so as to constrain frames 26 for movement in the y-direction only.

Coupling links 34, 36 interconnect proof mass 12 with detector frames 16, 26, respectively. Coupling links 34 are folded beams which extend in the x-direction and are relatively stiff in the x and z directions but flexible in the y-direction. Hence, links 34 couple x-axis movement of the proof mass to the movable electrodes 14 of detectors 13 while permitting the proof mass to move independently of detectors 13 in the y-direction. Similarly, coupling links 36 are folded beams which extend in the y-direction and are relatively stiff in the y and z directions but flexible in the x-direction. Thus, links 34 couple y-axis movement of the proof mass to the movable electrodes 24 of detectors 23 while permitting the proof mass to move independently of detectors 23 in the y-direction.

In use, the accelerometer is installed with its x and y axes aligned with the directions in which acceleration is to be monitored. When the device is accelerated along the x-axis, links 36 flex and allow proof mass 12 to move along that axis relative to the substrate, and links 34 couple that movement to the input electrodes 14 of x-axis detectors 13, increasing the capacitance of one detector and decreasing the capacitance of the other. Suspension beams 22 permit input electrodes 14 to move in the x-direction but prevent them from moving in the y-direction, thereby decoupling detectors 13 from movement of the proof mass along the y-axis. Further decoupling is provided by the flexibility of links 34 in the y-direction.

Similarly, y-axis detector 23 responds only to movement of the proof mass along the y-axis. Links 34 flex and allow proof mass 12 to move along the y-axis, and links 36 couple that movement to the input electrodes 24 of detectors 23, increasing the capacitance of one detector and decreasing the capacitance of the other. Suspension beams 32 permit input electrodes 24 to move in the y-direction but prevent them from moving in the x-direction, thereby decoupling detectors 23 from movement of the proof mass along the x-axis. Further decoupling is provided by the flexibility of links 36 in the x-direction.

Thus, the suspension beams which mount the input electrodes of the detectors and the links which interconnect the proof mass with the electrodes isolate the electrodes from orthogonal movement of the proof mass and permit the detectors to respond only to movement of the proof mass in the desired direction, thereby substantially eliminating cross axis sensitivity.

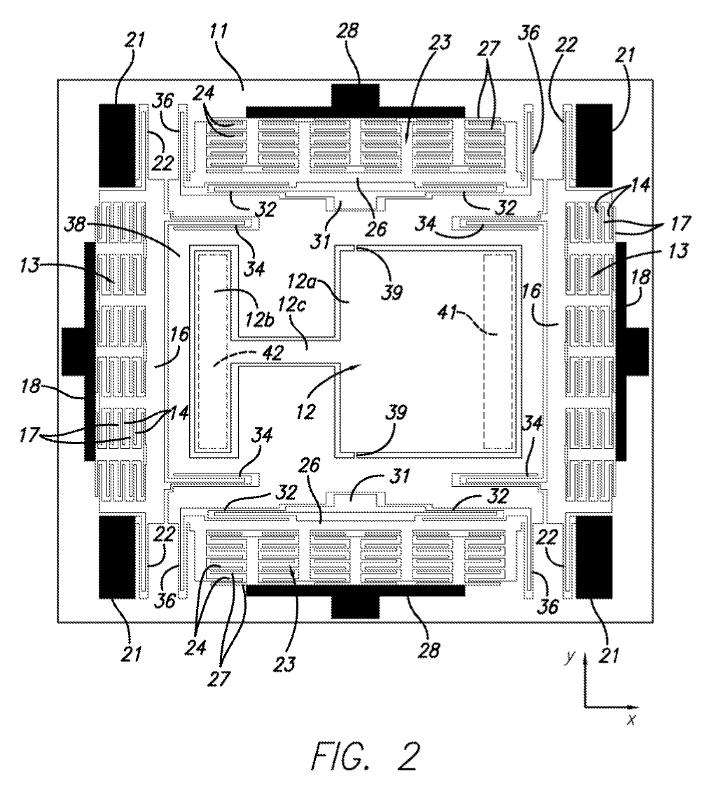

The embodiment of FIG. 2 is generally similar to the embodiment of FIG. 1, and like reference numerals designate corresponding elements in the two embodiments. In the embodiment of FIG. 2, however, the proof mass can also move in response to acceleration along a third axis, and the detector for sensing that movement is isolated from acceleration and movement along the other two axes.

Instead of being connected directly to proof mass 12 in this embodiment, coupling links 34, 36 are connected to a gimbal frame 38 which lies in the x-y plane and is free to move in the x and y directions. The proof mass has a large end section 12a and a small end section 12b on opposite sides of a relatively narrow central section 12c which extends along the x-axis. The proof mass is suspended from the gimbal frame by torsion springs or flexures 39 which are aligned along the y-axis and connected to the large end section near the inner edge of that section. The proof mass is thus mounted to the gimbal frame in an asymmetrical or imbalanced manner, and acceleration along the z-axis in a direction perpendicular to the substrate will produce an inertial moment and rotational movement of the proof mass about the y-axis. The torsion springs are relatively stiff in the x and y directions so the proof mass and the gimbal frame move together in those directions.

Sensing electrode plates 41, 42 are mounted on the substrate in fixed positions beneath the end sections of the proof mass to detect rotational movement of the proof mass about the y-axis. The electrode plates form capacitors with the proof mass which change value in opposite directions as the proof mass rotates about the axis.

Operation of the embodiment of FIG. 2 is similar to that of the embodiment of FIG. 1 insofar as detecting acceleration along the x and y axes is concerned, with proof mass 12 and gimbal frame 38 moving as a unit in the x and y directions in response to acceleration along the x and y axes.

Acceleration along the z-axis causes the asymmetrically mounted proof mass to rotate about the y-axis, thereby increasing the capacitance of the capacitor formed by one of the electrode plates 41, 42 and the proof mass and decreasing the capacitance of the other. That acceleration does not affect x and y detectors 13, 23 since their input electrodes 14, 24 are constrained against movement in the z direction. Similarly, the capacitors for sensing acceleration along the z-axis are not affected by acceleration along the x and y axes because movement of the proof mass along those axes does not change the spacing between the proof mass and the electrode plates beneath it.

As in the embodiment of FIG. 1, the suspension beams which mount the input electrodes of the x and y detectors and the links which interconnect the proof mass with those electrodes isolate the electrodes from orthogonal movement of the proof mass and permit the detectors to respond only to movement of the proof mass in the desired direction. In addition, the capacitors which detect acceleration along the z-axis are not affected by movement of the proof mass in the x and y directions, and acceleration in the z direction does not affect the x and y detectors. Thus, cross axis sensitivity is effectively eliminated between all three of the axes.

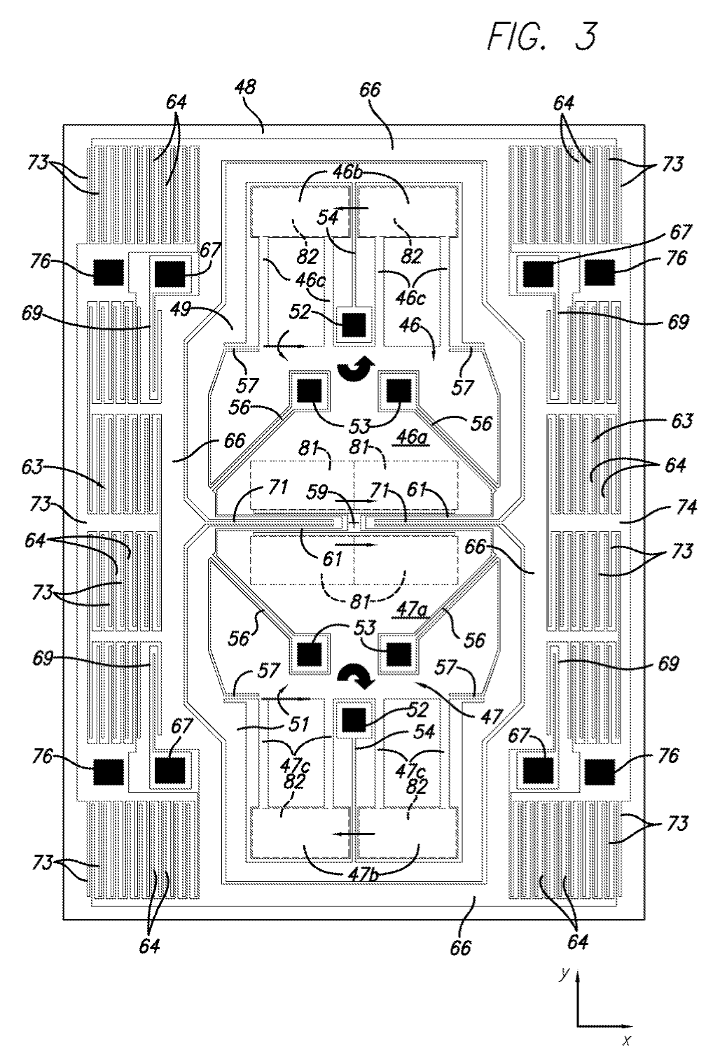

In the embodiment of FIG. 3, two generally planar proof masses 46, 47 are suspended above a substrate 48 for rotational or torsional movement about axes parallel to the x and z axes. The proof masses are mounted on U-shaped gimbals 49, 51 which are suspended from anchors 52, 53 by suspension beams or flexures 54, 56. Beams 54 extend along the y-axis, and beams 56 extend diagonally at an angle of approximately 45 degrees to the x and y axes. Those beams are relatively stiff or rigid in the z direction and constrain the gimbals for rotation about axes parallel to the z-axis.

Proof masses 46, 47 are suspended from gimbals 49, 51 by torsion springs or flexures 57 for rotational movement about axes which are parallel to the x-axis. The springs are relatively stiff or rigid in the x and y directions so that the proof masses and the gimbals move together in those directions. The proof masses have large inner sections 46a, 47a and a pair of relatively small outer sections 46b, 47b which are connected to the inner sections by rigid arms 46c, 47c that extend in the y direction. The proof masses are mounted on the gimbals in an asymmetrical or imbalanced manner, with the torsion springs being connected to the proof masses near the outer edges of the inner sections. Because of the imbalance of the masses, acceleration along the z-axis produces an inertial moment and rotational movement of the proof masses about the torsion springs.

The inner or adjacent edge portions of proof masses 46, 47 are connected together by a coupling 59 for movement in concert both along the x-axis and into and out of plane with respect to the gimbals. With the inner edges thus connected together, the two proof masses are constrained for rotation in opposite directions both about axes parallel to the x axis and about axes parallel to the z axis. The inner ends of the U-shaped gimbals are likewise connected together by couplings 61 which are relatively stiff or rigid in the x and z directions and flexible in the y direction. Those couplings constrain the inner ends of the gimbals for movement in concert in the x direction while permitting the gimbals to rotate about axes parallel to the z-axes.

Movement of the proof masses in response to acceleration along the x-axis is monitored by capacitive detectors 63 having input electrodes or plates 64 which are mounted on a frame 66 which surrounds the proof masses and gimbals and is suspended from anchors 67 by folded suspension beams 69 for linear movement in the x-direction. Beams 69 extend in the y direction and are flexible in the x-direction but relatively stiff in the y and z directions so as to constrain the frame for movement only in the x-direction. The frame is connected to the gimbals by links 71 which extend along the x-axis and are relatively stiff in the x direction and flexible in the y direction.

Input electrodes or plates 64 are interleaved with stationary electrodes or plates 73 which are mounted on frames 74 affixed to anchors 76 on the substrate to form capacitors 63 on opposite sides of the proof masses. As in the other embodiments, movement of the proof masses in response to acceleration along the x-axis causes the capacitance of the two capacitors to change in opposite directions.

Sensing electrode plates 81, 82 are mounted on the substrate in fixed positions beneath the inner and outer sections of the proof masses to detect out-of-plane rotation of the proof masses. The electrode plates form capacitors with the proof masses which change capacitance in opposite directions as the proof masses rotate into and out of plane.

In use, the accelerometer is oriented with the x and z axes extending in the directions in which acceleration is to be detected. When the device is accelerated along the x-axis, beams 54, 56 allow gimbals 49, 51 and proof masses 46, 47 to rotate about the z-axes. The masses rotate in opposite directions, with their inner edges moving in the same direction along the x-axis.

That movement is transferred to sensing frame 66 by links 71 to produce changes in the capacitance of capacitors 63. Since frame 66 is constrained for movement only along the x-axis, capacitors 63 are not affected by acceleration along the y or z axes.

Acceleration along the z-axis causes proof masses 46, 47 to rotate about the x-axes. That rotation produces a change in the capacitance of the capacitors formed by the proof masses and electrode plates 81, 82. As in the embodiment of FIG. 2, the capacitance of those capacitors is not affected by acceleration along the x or y axes because movement of the proof masses along those axes does not change the spacing between the proof masses and the electrode plates beneath them.

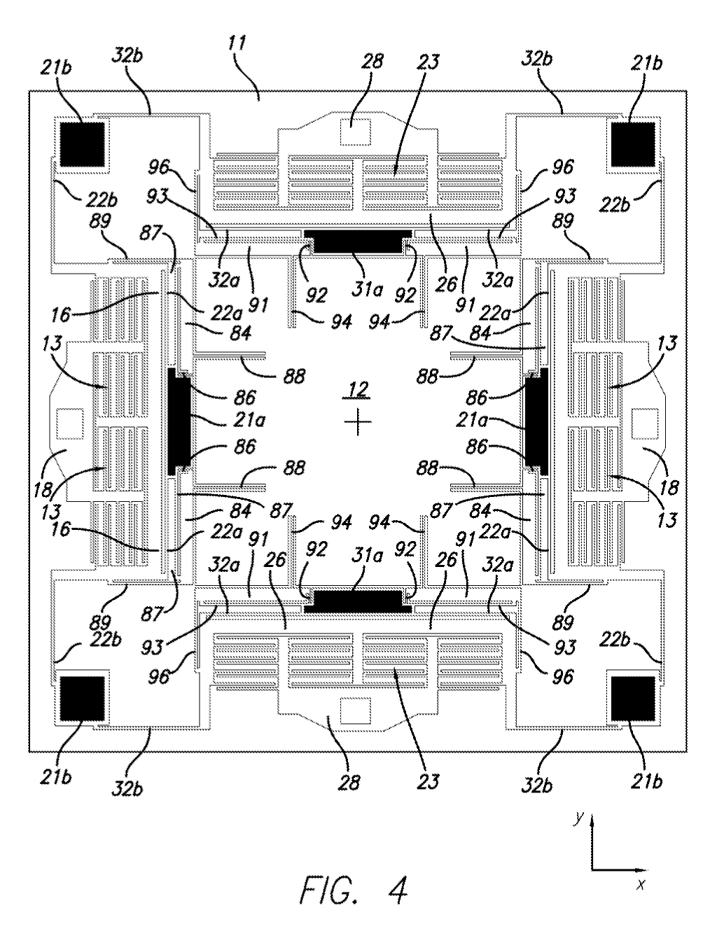

The embodiment of FIG. 4 is similar to the embodiment of FIG. 1 in that it has a generally planar proof mass 12 suspended above a substrate 11 for movement in the x and y directions, with sensing capacitors 13, 23 for detecting movement of the proof mass in those directions. The input frames 16 of capacitors 13 are suspended from anchors 21a, 21b by beams 22a, 22b which extend in the y-direction and are flexible in the x-direction but relatively stiff in the y and z directions so as to constrain frames 16 for movement in the x-direction only. The input frames 26 of capacitors 23 are suspended from anchors 31a, 21b by beams 32a, 32b which extend in the x-direction and are flexible in the y-direction but relatively stiff in the x and z directions so as to constrain frames 26 for movement in the y-direction only.

In this embodiment, deflection or movement of the proof mass in the x and y directions is applied to the sensing capacitors through levers which provide greater sensitivity by increasing or amplifying the movement. The levers which transfer the motion in the x-direction have arms 84 which extend in the y-direction and are connected to anchors 21a by flexures 86, 87 for rotation about fulcrums near the inner ends of the arms. The proof mass is connected to the lever arms near the inner ends of the arms by input links 88, and the lever arms are connected to the sensing capacitors by output links 89 which extend between the outer ends of the lever arms and the input frames 16 of the capacitors. Links 88, 89 extend in the x-direction and are rigid in that direction and flexible in the y-direction.

The levers which transfer the motion in the y-direction have arms 91 which extend in the x-direction and are connected to anchors 31a by flexures 92, 93 for rotation about fulcrums near the inner ends of the arms. The proof mass is connected to the lever arms near the inner ends of the arms by input links 94, and the lever arms are connected to the sensing capacitors by output links 96 which extend between the outer ends of the lever arms and the input frames 26 of the capacitors. Links 94, 96 extend in the y-direction and are rigid in that direction and flexible in the x-direction.

Operation and use of the embodiment of FIG. 4 is similar to that of the embodiment of FIG. 1, with the levers amplifying or increasing the movement of the input electrodes or plates of the sensing capacitors relative to the proof mass. This results from the fact that the input links are connected to the levers at points near the fulcrums, whereas the output links are connected to the levers at points removed from the fulcrums, with the increase in movement being proportional to the ratios of the distances between the links and the fulcrum.

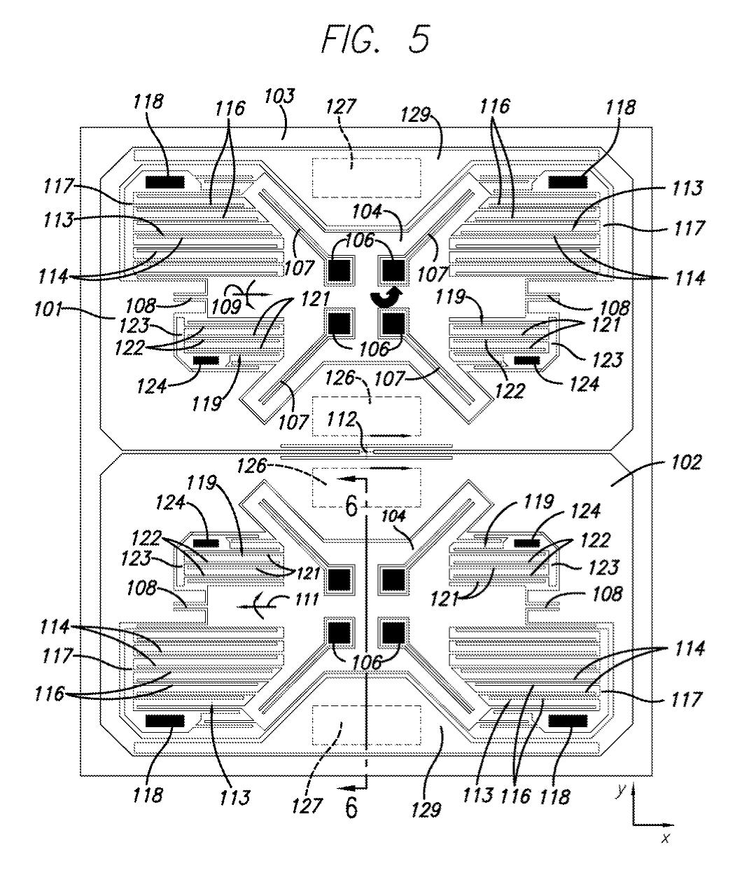

In the embodiment of FIG. 5, two generally planar proof masses 101, 102 are suspended above a substrate 103 for rotational or torsional movement about axes parallel to the x and z axes. The proof masses are mounted on inner frames 104 which are suspended from anchors 106 by suspension beams or flexures 107 which extend diagonally at an angle of approximately 45 degrees to the x and y axes. Those beams are relatively stiff or rigid in the z direction and constrain the frames for rotation about axes parallel to the z-axis.

Proof masses 101, 102 are suspended from frames 104 by torsion springs or flexures 108 for rotational movement about axes 109, 111 which are parallel to the x-axis. The springs are relatively stiff or rigid in the x and y directions so that the proof masses and the frames move together in those directions.

The inner or adjacent edge portions of proof masses 101, 102 are connected together by a coupling 112 for movement in concert both along the x-axis and into and out of plane with respect to the frames. With the inner edges thus connected together, the two proof masses are constrained for rotation in opposite directions both about axes parallel to the x axis and about axes parallel to the z axis.

Movement of the proof masses in response to acceleration along the x-axis is monitored by sensing capacitors 113 having input electrodes or plates 114 which extend in the x-direction from opposite sides of the outer portions frames 104. The input electrodes or plates are interleaved with stationary electrodes or plates 116 mounted on frames 117 affixed to anchors 118 on the substrate.

Smaller capacitors 119 are formed by movable electrodes or plates or electrodes 121 which extend from the inner portions of frames 104 and are interleaved with stationary electrodes or plates 122 mounted on frames 123 affixed to anchors 124 on the substrate.

Frames 104 and capacitors 113, 119 are located entirely within the lateral confines of proof masses 101, 102. Since capacitors 113 are larger than capacitors 119, the inner portions of the proof masses are heavier than the outer portions, and the imbalance in the masses causes the masses to rotate about axes 109, 111 when the masses are accelerated along the z-axis.

Sensing electrode plates 126, 127 are mounted on the substrate in fixed positions beneath the inner and outer portions of the proof masses to detect out-of-plane rotation of the proof masses. The electrode plates form capacitors with the proof masses which change capacitance in opposite directions as the proof masses rotate into and out of plane.

Acceleration in the x-direction produces torsional movement of the proof masses and the frames about axes perpendicular to the substrate and parallel to the z-axis. As the frames rotate, the electrodes or plates which extend from them move closer to or farther from the stationary electrodes, increasing the capacitance of the sensor on one side of each proof mass and decreasing the capacitance of the sensor on the other side. Since the inner portions of the two proof masses are connected together, the two masses rotate in opposite directions.

Acceleration in the z-direction produces out-of-plane rotational movement of the two proof masses about axes 109, 111, changing the capacitances between electrode plates 126, 127 and the proof masses. With the plates on opposite sides of the axes, the capacitances change in opposite directions, and with the inner portions of the masses connected together, the out of plane rotation of the two masses is also in opposite directions.

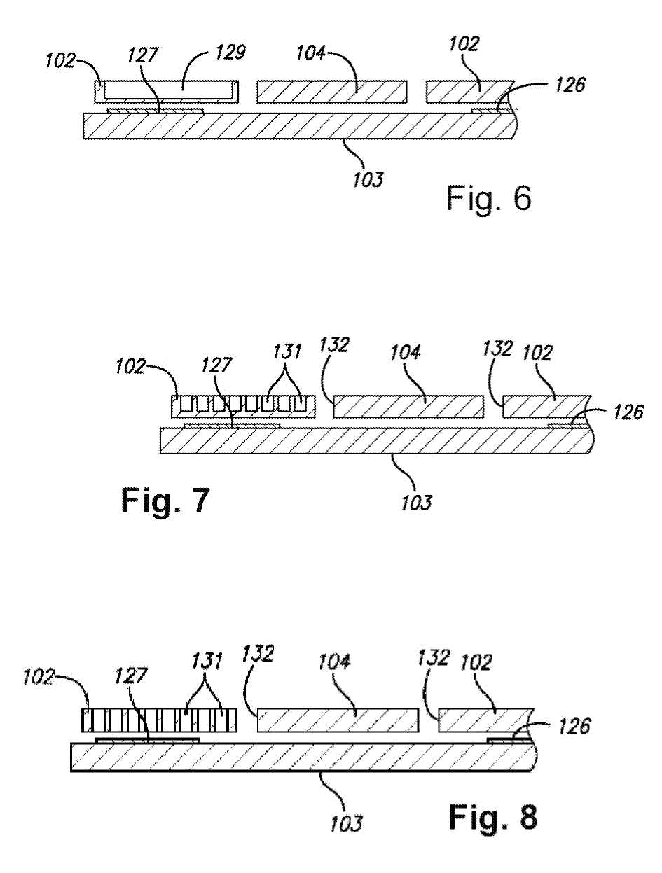

Sensitivity to acceleration along both the x and z axes can be increased by increasing the mass imbalance by removing material from the outer or lighter portions of the proof masses. Thus, in the embodiment of FIG. 5, recessed areas 129 are formed in the outer portions of the two masses, as further illustrated in FIG. 6. The recessed areas are formed by etching from the top side of the masses so as not to disturb the bottom surfaces of the masses and the capacitances between those surfaces and electrode plates 127.

Alternatively, as shown in FIG. 7, narrow trenches 131 can be formed in the outer portions of the proof masses. These trenches are formed by etching from the top side of the masses so as not to disturb the bottom surfaces. By making the trenches narrower than the gaps 132 between the proof masses and the frames and the gaps between other elements such as the capacitor electrodes or plates, the etching of the trenches will not reach the bottom surfaces, whereas the gaps are etched all the way through.

The embodiment of FIG. 8 is similar to the embodiment of FIG. 7 except that trenches 131 are etched all the way through the proof masses. Electro-static simulations have shown that with relatively narrow trenches, the symmetry of the capacitances between the bottoms of the proof masses and electrode plates 126, 127 is largely preserved even if the trenches extend through the bottom surfaces of the proof masses.

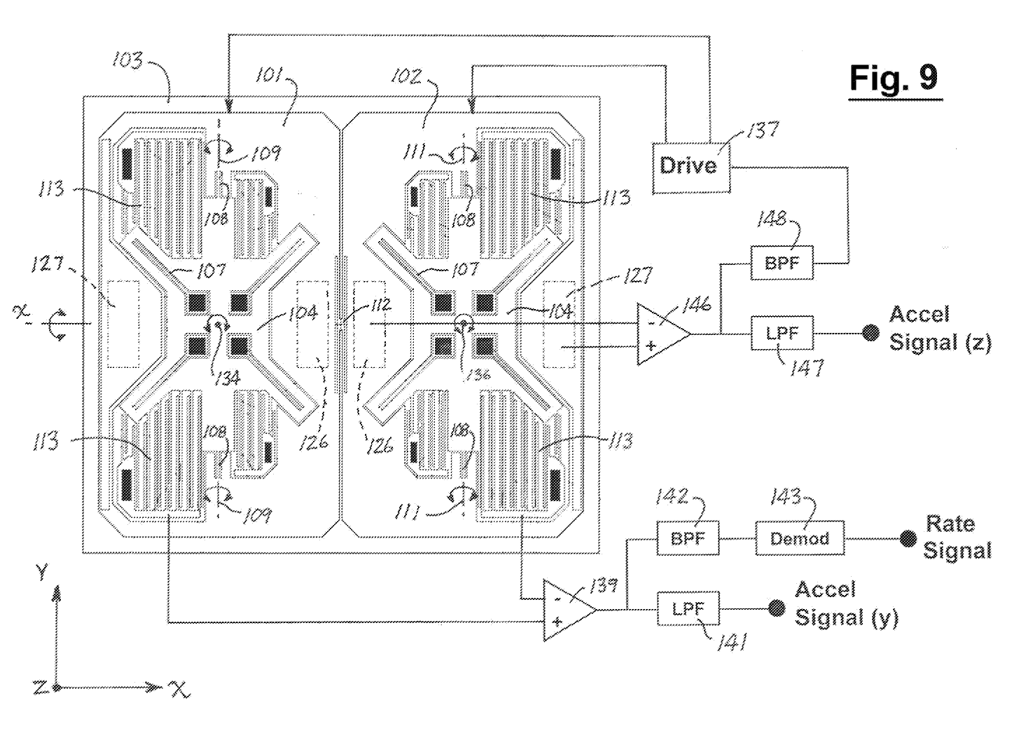

FIG. 9 illustrates a combined accelerometer and rate sensor using the structural embodiment of FIG. 6. In this embodiment, substrate 103 is turned so that the axes 109, 111 about which torsion springs or flexures 108 allow the masses 101, 102 to rotate are parallel to the y axis, and acceleration along the y and z axes is monitored. Acceleration in the y-direction produces torsional movement of the proof masses and frames 104 about axes 134, 136 which are perpendicular to the substrate and parallel to the z-axis, and acceleration in the z-direction produces out-of-plane rotational movement of the two proof masses about axes 109, 111. Since the masses are connected together along their inner edges, they move equally and in opposite directions about the two sets of axes.

In the embodiment of FIG. 9, a drive circuit 137 drives the two proof masses for oscillation in an anti-phase manner about axes 109, 111, and Coriolis forces produced by rotation of the device about the x axis cause torsional movement of the masses and frames about axes 134, 136.

In-plane torsional movement of the masses about axes 134, 136 is monitored by sensor capacitors 113, and signals from the capacitors are processed to provide output signals corresponding to acceleration along the y axis and rotation about the x axis. The acceleration signals occur at or near DC, whereas the masses are driven at the resonant frequency of the drive mode, which might, for example, be on the order of 4 KHz-10 KHz, and the rate signals occur at or near that frequency.

Capacitors 113 are connected to the inputs of a pre-amplifier 139, and the acceleration signals are extracted by a low-pass filter 141 connected to the output of the amplifier. A bandpass filter 142 having a center frequency corresponding to the drive frequency is also connected to the output of the amplifier, and signals from the bandpass filter are applied to a demodulator 143 to provide the rate signals.

Out-of-plane rotational movement of the masses about axes 109, 111 is monitored by sensor electrodes 126, 127 on the substrate beneath the masses, and signals from those electrodes contain information both about acceleration along the z axis and about the amplitude of the drive oscillation. The z-axis acceleration signals are at the baseband frequency, whereas the drive oscillation signals are at the drive frequency.

Electrode plates 126, 127 are connected to the input of a second pre-amplifier 146, and the acceleration signals are extracted by a low-pass filter 147 connected to the output of the amplifier. A bandpass filter 148 having a center frequency corresponding to the drive frequency is connected between the output of amplifier 146 and drive circuit 137 to provide feedback to the drive oscillation circuit.

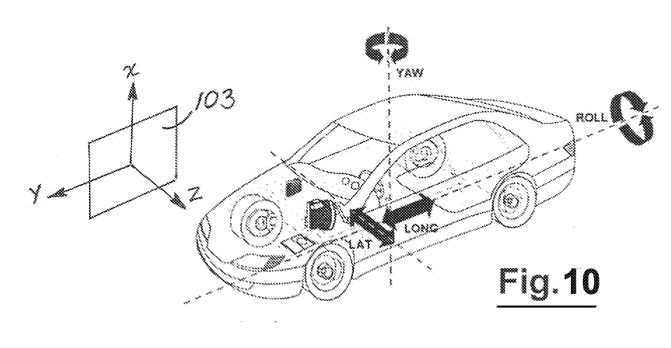

FIG. 10 illustrates the use of the embodiment of FIG. 9 for monitoring lateral acceleration, longitudinal acceleration, and yaw rotation in a vehicle 149. In this embodiment, the device is oriented with its y axis aligned with the longitudinal acceleration axis of the vehicle, its z axis aligned with the lateral acceleration axis, and its x axis extending vertically along the yaw axis.

Thus, either acceleration along the longitudinal axis or rotation about the yaw axis will produce torsional movement of the masses about axes 134, 136, and acceleration along the lateral axis will produce rotational movement of the masses about axes 109, 111. The acceleration and rate signals are separated and processed in the manner discussed above, with the output signals corresponding to acceleration along the longitudinal and lateral axes and to the rate of rotation about the yaw axis.

The embodiment shown in FIG. 3 can also be used to monitor rate of rotation as well as acceleration. To do so, masses 46, 47 are driven to oscillate in an out-of-plane manner about flexures 57, and rotation of the device about the y axis produces in-plane torsional movement about the axes perpendicular to the substrate. Signals from sensor capacitors 63 are filtered and processed to separate the x-axis acceleration signals from the y-axis rotation signals, and signals from electrode plates 81, 82 are filtered and processed to provide an output signal for z-axis acceleration and a feedback signal for the drive circuit.

The accelerometer and rate sensor can be manufactured by any suitable micromachining process, with a presently preferred process being deep reactive ion etching (DRIE) of a single crystal silicon wafer. This process is compatible with a process employed in the manufacture of micromachined gyroscopes, which could reduce development time and permit the accelerometers to be fabricated at the same foundries as the gyroscopes and even on the same wafers.

The invention has a number of important features and advantages. With the detectors responsive to acceleration in only the desired directions, cross axis sensitivity is effectively eliminated. In the embodiments of FIGS. 1 and 2, multi-axis measurements are achieved with a single proof mass, which results in significantly smaller die size than in accelerometers having a separate proof mass for each direction. In addition, the detectors have a relatively large overall plate area, which can provide a relatively high signal-to-noise ratio even in low-g applications. Sensitivity is increased by the use of levers between the proof mass and the detectors in the embodiment of FIG. 4.

In the embodiments of FIG. 3 and 5, the gimbal and frame structures effectively decouple responses of the proof masses to acceleration along the x and z axes, thereby minimizing cross-talk, and with a sensing frame which is restricted to motion along the x-axis, the response of the x detector to accelerations in other directions is also minimized. In addition, external angular acceleration inputs are nulled out by the symmetrical torsionally mounted proof masses which are connected together for movement in opposite directions by a rigid link.

Moreover, as discussed above, the embodiments of FIGS. 3 and 5 can be used for monitoring rate of rotation as well as acceleration along multiple axes, with the orientations of the sensitive axes of the accelerometers and the input axis of the rate sensor being such that a single device can be used for monitoring lateral acceleration, longitudinal acceleration and yaw rotation in a vehicle.

It is apparent from the foregoing that a new and improved multi-axis micromachined accelerometer and rate sensor has been provided. While only certain presently preferred embodiments have been described in detail, as will be apparent to those familiar with the art, certain changes and modifications can be made without departing from the scope of the invention as defined by the following claims.

1. A micromachined accelerometer and rate sensor for detecting acceleration along first and second axes and rate of rotation about a third axis, comprising: a mass mounted for torsional movement about the first axis in response to acceleration along the second axis and for rotational motion about the second axis in response to acceleration along the first axis, means for driving the mass to oscillate about the second axis in a drive mode so that Coriolis forces produced by rotation about the third axis result in torsional movement of the mass about the first axis, a first sensor for monitoring torsional movement of the mass about the first axis, a second sensor for monitoring rotational movement of the mass about the second axis, means responsive to signals from the first sensor for providing output signals corresponding to acceleration along the second axis and rate of rotation about the third axis, and means responsive to signals from the second sensor for providing an output signal corresponding to acceleration along the first axis.

2. The accelerometer and rate sensor of claim 1 wherein the mass is generally planar and is spaced from a substrate, with the first axis perpendicular to the substrate and the second and third axes parallel to the substrate.

3. The accelerometer and rate sensor of claim 2 wherein the mass is mounted on an inner frame for rotational movement about the second axis, and the inner frame is mounted to the substrate for torsional movement about the first axis.

4. The accelerometer and rate sensor of claim 1 wherein the mass is driven to oscillate at the resonant frequency of the drive mode.

5. The accelerometer and rate sensor of claim 1 wherein the mass is driven to oscillate at a frequency on the order of 4 kHz-15 kHz.

6. The accelerometer and rate sensor of claim 1 wherein the means for providing output signals corresponding to acceleration along the second axis and rotation about the third axis includes filters for selectively passing signals from the first sensor corresponding to acceleration along the second axis and rotation about the third axis.

7. The accelerometer and rate sensor of claim 6 wherein the filters include a low pass filter for passing signals corresponding to acceleration and a bandpass filter for passing signals corresponding to rotation.

8. A micromachined accelerometer and rate sensor for detecting acceleration along first and second mutually perpendicular axes and rate of rotation about a third axis perpendicular to the first and second axes, comprising: first and second generally planar masses disposed side-by-side and connected together along adjacent edge portions thereof for torsional movement about axes parallel to the first axis in response to acceleration along the second axis and for rotational motion about axes parallel to the second axis in response to acceleration along the first axis, means for driving the masses to oscillate about the axes parallel to the second axis so that Coriolis forces produced by rotation about the third axis result in torsional movement of the masses about the axes parallel to the first axis, first sensors for monitoring torsional movement of the masses about the axes parallel to the first axis, second sensors for monitoring rotational movement of the masses about the axes parallel to the second axis, means responsive to signals from the first sensors for providing output signals corresponding to acceleration along the second axis and rate of rotation about the third axis, and means responsive to signals from the second sensors for providing an output signal corresponding to acceleration along the first axis.

9. The accelerometer and rate sensor of claim 8 wherein the masses are spaced from and generally planar to a substrate, with the first axis perpendicular to the substrate and the second and third axes in a plane parallel to the substrate.

10. The accelerometer and rate sensor of claim 8 wherein the sensors comprise capacitors having capacitances corresponding to the torsional and rotational positions of the masses.

11. The accelerometer and rate sensor of claim 10 wherein the means for providing output signals corresponding to acceleration along the second axis and rotation about the third axis includes filters for selectively passing signals from the capacitors corresponding to acceleration along the second axis and rotation about the third axis.

12. A micromachined accelerometer and rate sensor for detecting acceleration along lateral and longitudinal axes of a vehicle and rate of rotation about a yaw axis, comprising: a mass mounted for torsional movement about the lateral axis in response to acceleration along the longitudinal axis and for rotational motion about the longitudinal axis in response to acceleration along the lateral axis, means for driving the mass to oscillate about the longitudinal axis in a drive mode so that Coriolis forces produced by rotation about the yaw axis result in torsional movement of the mass about the lateral axis, and means responsive to movement of the mass about the lateral and longitudinal axes for providing output signals corresponding to acceleration along the lateral and longitudinal axes and to rate of rotation about the yaw axis.

13. The accelerometer and rate sensor of claim 12 wherein the mass is generally planar and is spaced from a substrate, with the lateral axis perpendicular to the substrate and the longitudinal and yaw axes parallel to the substrate.

14. The accelerometer and rate sensor of claim 12 wherein the mass is driven to oscillate at the resonant frequency of the drive mode.

15. The accelerometer and rate sensor of claim 12 wherein the mass is driven to oscillate at a frequency on the order of 4 kHz-15 kHz.

16. A micromachined accelerometer and rate sensor for detecting acceleration along first and second axes and rate of rotation about a third axis, comprising: a mass mounted for torsional movement about the first axis in response to acceleration along the second axis and for rotational motion about the second axis in response to acceleration along the first axis, means for driving the mass to oscillate about the second axis so that Coriolis forces produced by rotation about the third axis result in torsional movement of the mass about the first axis, a first sensor for monitoring torsional movement of the mass about the first axis, a second sensor for monitoring rotational movement of the mass about the second axis, a first filter connected to the first sensor for passing signals corresponding to acceleration along the second axis, a second filter connected to the first sensor for passing signals corresponding to rate of rotation about the third axis, and a filter connected to the second sensor for passing signals corresponding to acceleration along the first axis.

17. The accelerometer and rate sensor of claim 16 wherein the first filter is a low-pass filter, and the second filter is a bandpass filter.

18. The accelerometer and rate sensor of claim 16 wherein the filter connected to the second sensor is a low-pass filter.

19. The accelerometer and rate sensor of claim 16 wherein the means for driving the mass to oscillate about the second axis comprises a drive circuit with a filter providing feedback signals to the drive circuit from the second sensor.

20. The accelerometer of claim 19 wherein the filter which provides feed back signals to the drive circuit is a bandpass filter.
